(19) United States
(12) Patent Application Publication
(10) Pub. No.: US 2007/0271732 A1
(43) Pub. Date: Nov. 29, 2007

(54) End-Stop Damper

(75) Inventors: Ulrich Bantle, Empfingen (DE); Juergen Eschle, Aichhalden (DE)

Correspondence Address: PAULEY PETERSEN & ERICKSON, 2800 WEST HIGGINS ROAD, SUITE 365, HOFFMAN ESTATES, IL, 60195, US

(73) Assignee: KARL SIMON GMBH & CO. KG, Aichhalden (DE)

(21) Appl. No.: 10/581,584

(22) PCT Filed: Nov. 27, 2004
(86) PCT No.: PCT/EP04/13503

§ 371 Date: Jun. 11, 2007

(30) Foreign Application Priority Data
Dec. 2, 2003 (DE) 103 56 234.6
Sep. 14, 2004 (DE) 10 2004 044 898.1

(51) Int. Cl. E05F 5/02

(52) U.S. Cl. 16/84; 16/85

(57) ABSTRACT

An end stop damper including a stop element, guided in an elongate damper body with an opened and a closed end as well as a receiving chamber, for receiving a sliding piece, joined to the stop element. The end of the sliding piece, which extends into the receiving chamber, forms a cavity with the inner contour of the receiving chamber. The cavity has at least one opening, for reducing the air pressure. The opening cooperates with a damping element which creates a flow resistance for the air, escaping through the opening.

### BACKGROUND OF THE INVENTION

1. Field of the Invention

This invention relates to a door-closing damper, such as is used in the manufacture of furniture, and particularly for furniture doors and drawers.

2. Discussion of Related Art

Damping elements are known which are used to let the doors and drawers of furniture return gently into their closed end position. It is intended to prevent an abrupt and therefore annoying touching of parts of furniture, to limit wear and to obtain a noise-damping and shock-damping effect.

The known damping elements substantially have an elastic stop element fixed in a blind bore cut into the furniture body. The stop element can also be glued on the furniture body. Such a stop element protrudes beyond the flat surface of the piece of furniture and, because of its elastic deformability, it lessens the impact of a further furniture element, such as a furniture door, for example.

However, one problem arises with cabinets hung from a wall with cabinet doors seated in horizontally extending rotating hinges, and with lids which are hingedly connected with chests. Because of their inherent weight, the cabinet doors or covers of the chests impact with a large force on the damping elements applied in the conventional manner. In this case, the damping elements are not capable of damping such strong impacts in a satisfactory manner. It is thus necessary for the conventional damping elements to have disproportionally large dimensions, so that a complete closing of the cabinet door would not be possible.

Such a door-closing damper is known from Patent Abstracts of Japan, Publication No. 2001 140530 A. The known door-closing damper comprises a stop element guided in an elongated damper body with an open end and a closed end. The damper body has a receiving chamber for receiving a sliding element, which is connected with the stop element and on whose exterior one or several sliding faces are arranged, which rest against a section of the interior wall of receiving chamber assigned to the open end of the damper body. A sealing device resting against the inner contour of the receiving chamber is arranged on the end of the sliding element projecting into the receiving chamber. The end of the sliding element projecting into the receiving chamber and the sealing device form a hollow space together with the inner contour of the receiving chamber in which, when the sliding element is charged with pressure, a counter-pressure is exerted on the sliding element as a result of the air pressure built up in the hollow space. The hollow space has at least one opening for the escape of the air for reducing the air pressure.

In a door-closing damper the damping effect results from the fact that the opening is in the form of a bore in the closed end of the damper body and is chosen to be very narrow, so that the air slowly escapes from the hollow space for reducing the air pressure. The typical diameter of such a bore is approximately 0.1 mm. Because door-closing dampers are mostly produced in large quantities by injection-molding methods, and because it is very difficult to make such narrow bores by such a production method, the desired damping effect is not dependably provided. Moreover, in actual use problems occur regarding the dimensional accuracy of such narrow bores during continuous use. This leads to a widening of the bore diameter, and therefore to a worsening of the damping effect.

### SUMMARY OF THE INVENTION

It is one object of this invention to provide a door-closing damper of the type described above which, with simple construction, assures an effective damping effect even during continuous operation.

This object and others of this invention can be accomplished with a door-closing damper having the characteristics described in this specification and in the claims.

Accordingly, a damping member, which forms a flow resistance to the air escaping through the opening, works together with the opening. When employing such a damping member it is not necessary to choose the opening, or bore, to be especially small for letting the compressed volume of air escape slowly. Instead, the opening can be selected to be of any arbitrary size, because the air volume flows through the damping member and escapes damped. Openings of a diameter of greater than 0.1 mm can also be realized by an injection-molding process. In order to achieve the desired damping effect, an exactly predefined diameter of the opening is not as important as the damping member used.

Thus, the damping member can have a porous material as the air flow resistant material. With such a material the air flows through a plurality of narrow flow channels, so that a desired flow resistance is achieved.

In one embodiment, the damping member can have an element made of a sinter metal, a plastic foam, a textile material, a felt material or such material providing a resistance to air flow. An entire list of suitable materials is available, which differ with respect to their abilities to be processed, to resistability, to their tendency to be clogged by particles in the air, and other properties of the material. However, it is common for the materials used for a flow to take place through them and they provide a resistance to flow, which leads to damping in the door-closing damper.

The opening through which flow occurs can be arranged at the closed end of the damper body. It is possible to form the opening in this area by a particularly simple manufacturing technology. It is thus possible to select the diameter of the opening to be from greater than 0.1 mm up to the interior diameter of the hollow space. The damping member can be arranged or fitted into a support area formed on the damper body, wherein the entire air flow passes through the damping member. If the interior diameter of the hollow space is selected as the diameter of the opening, the damping member can be directly pressed into the damper body and can define the closed end of the damper body. Alternatively or in addition, the opening can be arranged on the sliding element. Because the sliding element extends at least partially into the outer area of the door-closing damper, an opening made in the sliding element assures the particularly good escape of the compressed air from the hollow space. Thus it is possible to provide a bore applied in the direction of the extension of the sliding element, which extends as far as the hollow space. The damping member can be arranged or fitted into a support area formed in the damper body, wherein an entire air flow passes through the damping member. In this case the damping member can be directly pressed into the bore.

It can be advantageous in view of manufacturing technology to arrange the damping member on the side of the opening facing away from the hollow space. If a support area can be formed on the side of the opening facing away from the hollow space, the damping member can be fitted there in a suitable manner.

Alternatively or additionally, it is possible to arrange the damping member at the side of the opening facing the hollow space so that the support area is located on the same side. A dependable support in the support area is also assured by the preselected flow direction of the air.

The damping member can also be fitted inside the opening. This arrangement is particularly advantageous if the opening has a diameter greater than 0.1 mm.

So that in a state in which it is not charged the sliding element is substantially automatically extended, or remains in the extended position until it comes into contact with a piece of furniture, a spring is on the damper body, which is arranged in the receiving chamber. The spring pushes the sliding element at least partially out of the receiving chamber. The sliding element can be easily pushed into the receiving chamber against the spring force. The damping effect is primarily achieved by the air pressure being built up.

In accordance with one embodiment, the sealing device has at least one elastic sealing lip. When air pressure is built up in the hollow space which is formed by the end of the sliding element with the sealing device extending into the receiving chamber and the inner contour of the receiving chamber, the sealing lip is pushed against the inner contour of the receiving chamber, so that a sliding connection is created which is air-tight, to a large extent.

In one embodiment which is cost-effective, the elastic sealing lip is substantially inclined in the direction toward the closed end of the receiving chamber. In this case the sealing lip is arranged or spaced apart, at least partially, from the outer contour of the sliding element and at the end of the sliding element extending into the receiving chamber.

So that the sliding element can be brought into a maximally extended position even with the underpressure created in the hollow space when pulled out or pushed out by the spring, the sealing lip permits the flow of air into the hollow space. During this, because of the underpressure being created in the hollow space, the elastic sealing lip of the sealing device in the space between the inner contour of the receiving chamber and the outer contour of the sliding element is spaced apart from the inner contour of the receiving chamber during the at least partial pulling-out of the sliding element from the receiving chamber. Thus air can flow through the space between the inner contour of the receiving chamber and the outer contour of the sliding element beyond the sealing lip into the hollow space. A particularly simply constructed and at the same time effective sliding guidance is created because at least one protrusion is formed on the inner wall section of the receiving chamber associated with the open end of the damper body, which is in contact with each sliding face of the sliding element. The sliding element is dependably guided in the receiving chamber, together with the sealing device, which forms a supporting and sealing sliding guidance on the inner wall of the receiving chamber.

So that the sliding element cannot be completely pulled out of the receiving chamber or can be pushed out by the spring, at least one protrusion is formed between the outer contour of the sliding element and the inner contour of the receiving chamber. During the at least partial pull-out of the sliding element from the receiving chamber, the protrusion strikes the protrusion formed on the inner wall section of the receiving chamber associated with the open end of the damper body. Thus, an effective contact stop is easily formed.

For a simple installation of the door-closing damper, the damper body can be inserted into a blind bore in, for example, a furniture body. For limiting the insertion depth of the damper body in the blind bore, the damper body has a shoulder which encircles it at least partially on an outer contour associated with the open end.

For the dependable reception of the spring, the sliding body has an elongated recess which, at least partially, extends substantially in the direction of its longitudinal extension and is arranged at its end associated with the closed end of the receiving chamber, into which the spring arranged in the receiving chamber extends.

So that the hollow chamber, between the end of the sliding element extending into the receiving chamber and the inner contour of the receiving chamber, which is extended by the elongated recess in the sliding element, is minimized in the pushed-in state of the sliding element, a pin, which extends in the longitudinal extension direction of the receiving chamber, is formed on the inner contour of the closed end of the receiving chamber. In the completely pushed-in state of the sliding element, the pin extends substantially completely into the recess of the element which runs in the direction of the longitudinal extension.

In order to house the spring in a particularly space-saving manner while simultaneously minimizing the volume of the hollow chamber in the pushed-in state of the sliding element, the spring arranged in the receiving chamber can be conducted over the pin and movably arranged on the outer contour of the pin, so that there is no interference with the spring path. At the same time, it is possible to form a space between the pin and the recess extending in the longitudinal extension direction in the sliding element, so that the spring is movably arranged on the inner contour of the recess and so that its spring travel is not hampered.

A particularly effective minimization of the volume of the hollow chamber is achieved if, with the sliding element substantially completely pushed-in, the spring is squared away or positioned in the space between the pin and the recess.

The stop element can have a detent head which projects at least partially over the edge area of the opening at the open end of the damper body and which, with the substantially completely pushed-in sliding element, is stopped on the edge area and thus defines an additional limit of the insertion depth of the sliding element into the receiving chamber in the damper body.

In one embodiment, which has simple manufacturing techniques, the sliding body can be designed in one piece with the sealing device.

For example, in order to releasably maintain a cabinet door on the furniture body in the closed position, the stop element can have a magnetic snap-in arrangement or similar contact device for the releasable connection of the door-closing damper.

In accordance with another embodiment of a door-closing damper of this invention, the door-closing element has a magnetic snap-in arrangement or similar contact device for the releasable connection of the door-closing damper with a connecting element. Under these cross-sectional conditions, it is possible to achieve a continuous pressure reduction with a sufficient damping effect. In this case, damping is just large enough so that the door-closing damper can be advantageously employed in furniture construction. In this case, the diameter of the opening can be less than 0.1 mm.

Such opening cross sections are atypical in connection with this invention, and they are very difficult to manufacture. However, with such an embodiment, it is possible to definitely act on the varying flow conditions in the pressure release phase, so that good damping is achieved for a door-closing damper.

### DETAILED DESCRIPTION OF THE INVENTION

This invention is explained in greater detail in view of exemplary embodiments represented in the drawings, wherein:

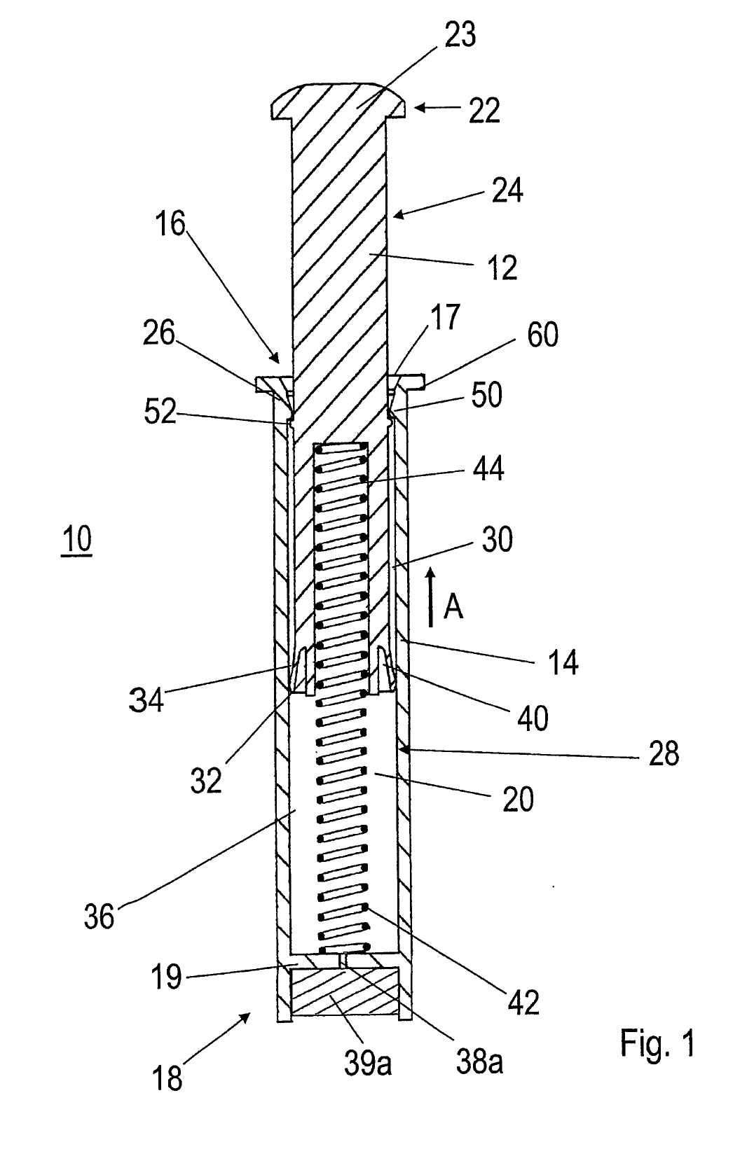

FIG. 1 shows a door-closing damper in a lateral and sectional view, in accordance with one embodiment, having a damping member arranged at the closed end of the damper body, and with the sliding element completely extended;

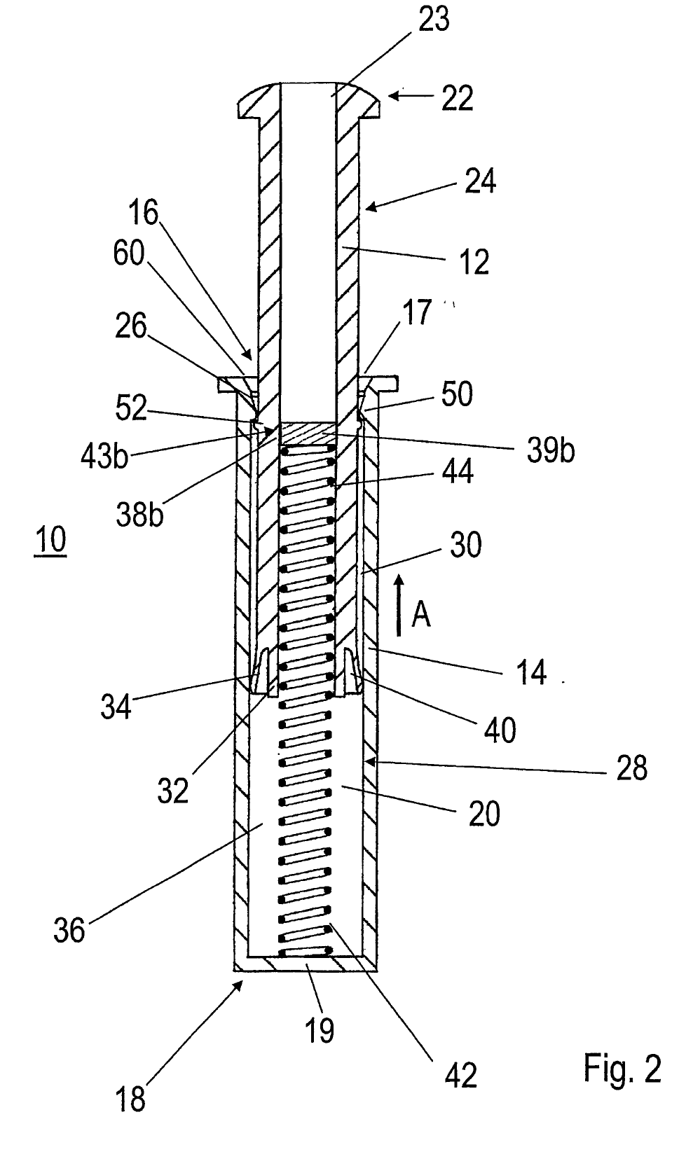

FIG. 2 shows a door-closing damper in a lateral and sectional view in accordance with a further embodiment, having a damping member arranged at the sliding element, wherein the sliding element is shown completely extended;

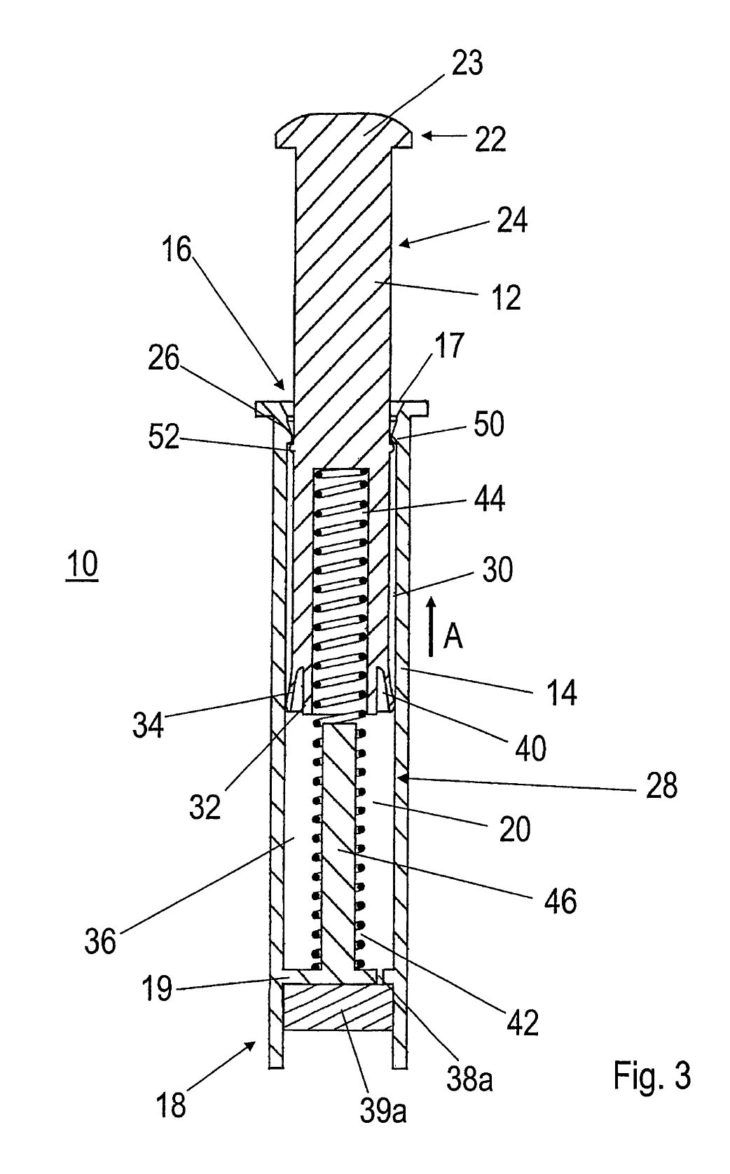

FIG. 3 shows a door-closing damper in a lateral and sectional view in accordance with a still further embodiment, having a damping member arranged at the closed end of the damper body, a pin arranged in the hollow chamber, and with the sliding element completely extended;

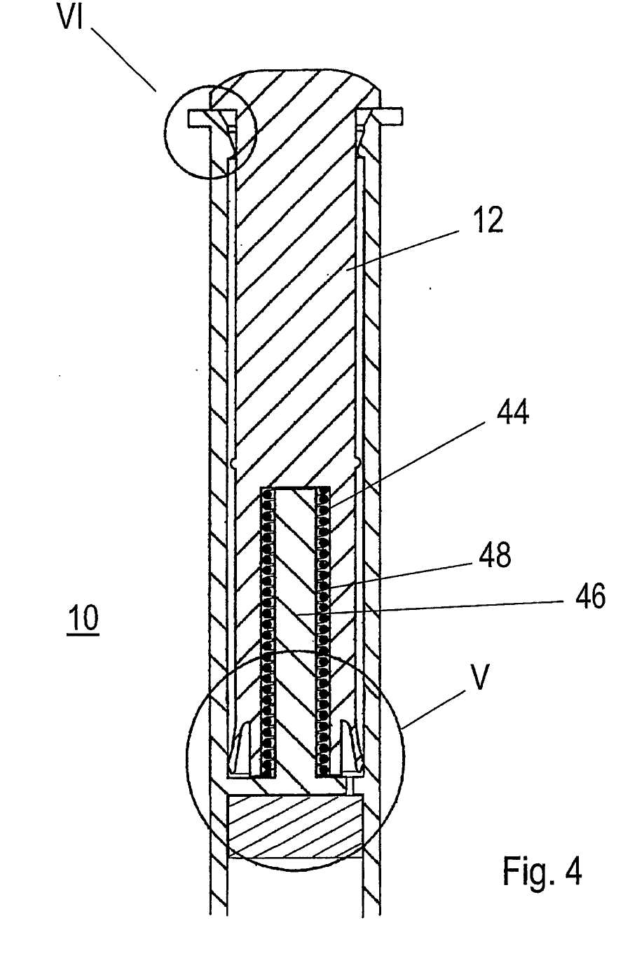

FIG. 4 shows a door-closing damper in accordance with FIG. 3, in a lateral and sectional view, with the sliding element completely pushed in;

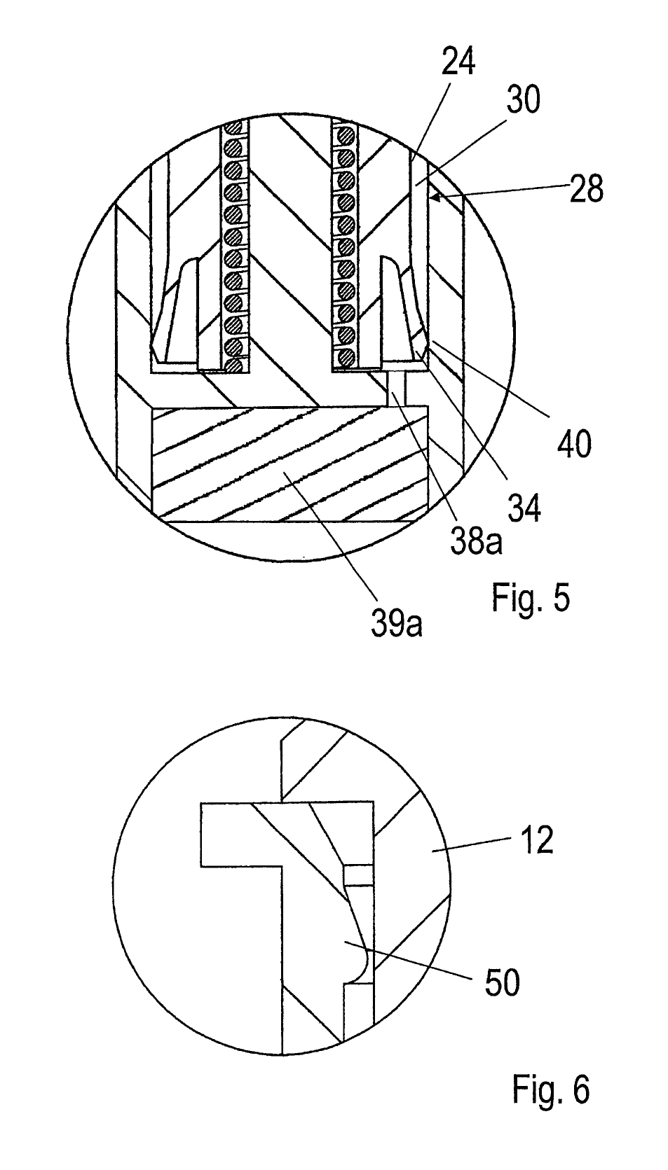

FIG. 5 shows an enlarged partial lateral and sectional view of FIG. 4, which includes the lower closed area of the damper body with the sliding element completely pushed in, in accordance with one embodiment;

FIG. 6 shows an enlarged partial lateral and sectional view of FIG. 4, which includes an area arranged at the outer contour of the damper body at the open end of the receiving chamber, in accordance with another embodiment;

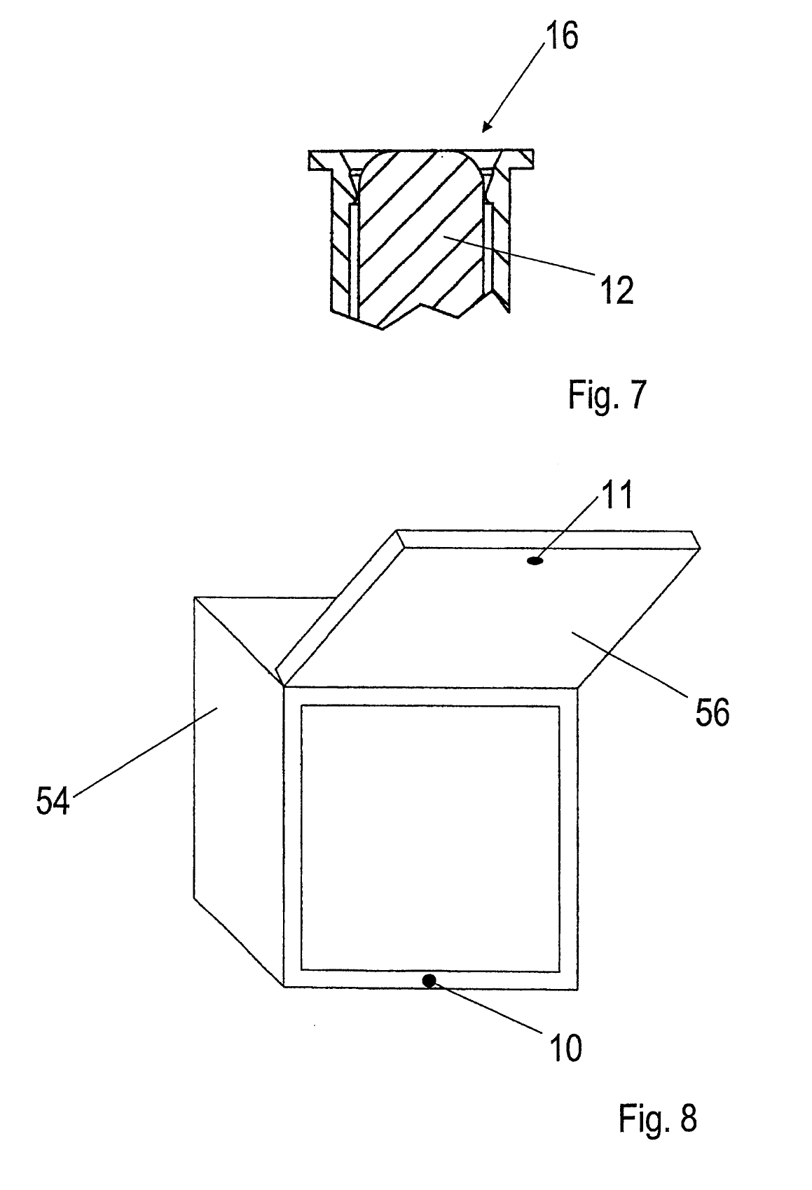

FIG. 7 shows a partial lateral and sectional view of an upper open area of the damper body with the sliding element completely pushed in, in accordance with an alternative embodiment; and

FIG. 8 shows a schematic perspective view of a furniture body with a closing flap, which is damped by a door-closing damper.

### DETAILED DESCRIPTION OF THE INVENTION

In a lateral representation and in a sectional view, FIG. 1 shows a door-closing damper 10 in accordance with a first embodiment, having a damping member 39a arranged at the closed end 18 of the damper body 14 and with the sliding element 12 completely extended. The door-closing damper 10 has an elongated cylinder-shaped damper body 14 with an upper open end 16 and a lower closed end 18. The damper body 14 has a cylinder-shaped receiving chamber 20 for receiving the cylinder-shaped sliding element 12, which is connected with a stop element 22. The stop element 22 has a detent head 23, which projects, at least partially, past or beyond the edge area 17 of the opening at the open end 16 of the damper body 14 and which, with the sliding element 12 substantially completely pushed in, engages the edge area 17.

The sliding element 12 has a sliding surface on its outer contour 24, which rests against an inner wall section 26 of the receiving chamber 20 assigned to the open end 16 of the damper body 14. A gap 30 is between the outer contour 24 of the sliding element 12 and the inner contour 28 of the receiving chamber 20 in the entire section arranged underneath the sliding guide 26. A sealing lip 34 resting against the inner contour 28 of the receiving chamber 20 is arranged at the end 32 of the sliding element 12 extending into the receiving chamber 20. The sealing lip 34 is produced in one piece with the sliding element 12 by a plastic injection process.

The end 32 of the sliding element 12 protruding into the receiving chamber 20 forms a hollow chamber 36 together with the sealing lip 34 and with the inner edge 28 of the receiving chamber 20. A counter-pressure in the direction A, generated by the air pressure built up in the hollow chamber 36, is exerted in the hollow chamber 36 when the sliding element 12 is charged with pressure, for example by a cover of a chest, not shown.

The elastic lip 34 is arranged on the end 32 of the sliding element 12 which projects into the receiving chamber 20. The elastic sealing lip 34 is substantially inclined in the direction toward the closed end 18 of the receiving chamber 20. Thus, the sealing lip 34 extends substantially in the longitudinal direction and parallel with the inner contour of the receiving chamber 20. During this, in its area oriented in the direction to the closed end of the receiving chamber 20, the sealing lip 34 forms a recess 40, approximately ring-shaped in cross section, which is a part of the hollow chamber 20. When air pressure is built up in the hollow chamber 20, the air pressure within the ring-shaped recess 40 will also rise correspondingly, so that the sealing lip 34 is pressed against inner contour 28 of the receiving chamber 20 and a sliding connection is formed, which is air-tight to a large extent.

When pulling the sliding element 12 at least partially out of the receiving chamber 20, a definite underpressure with respect to the ambient pressure is created in the hollow chamber 36 because of the sealing effect of the sealing lip 34. If the elastic sealing lip 34 is thus appropriately designed regarding its yielding ability, it can be lifted off the inner contour 28 of the receiving chamber 20 because of the higher air pressure in its surroundings and in the gap 30 contacting it. During this, air can flow past the sealing lip 34 through the gap 30 between the inner contour 28 of the receiving chamber 20 and the outer contour 24 of the sliding element 12, into the hollow chamber 36 until a pressure equilibrium is achieved. The sealing lip 34 can be designed stiff enough so that the pressure equalization takes place only via the damping member 39a.

The damper body 14 has a helical spring 42 arranged in the receiving chamber 20, which extends in the receiving chamber 20 from the closed end 18 to the lower end 32 of the sliding element 12. The spring 42 pushes the sliding element 12 at least partially out of the receiving chamber 20. The sliding element 12 can be pushed into the receiving chamber 20 against the spring force of the spring 42.

The sliding element 12 has a recess 44, which extends in the direction of its longitudinal extension and is attached on its end 32 associated with the closed end 18 of the receiving chamber and into which the spring 42 arranged in the receiving chamber 20 extends.

A bottom plate 19, on which the spring 42 is supported and which delimits the hollow chamber 36, is formed in one piece with the damper body 14 on the closed end 18. An opening 38a in the form of a bore is cut approximately centered into the bottom plate 19. A damping element 39a made of a porous material, for example a sinter material, is arranged on the side of the bore 38a facing away from the hollow chamber 36. The damping element 39a is used as a flow resistance material for the air flowing out of the opening 38a.

A support area 43a for the damping element 39a is formed on the side of the bottom plate 19 facing away from the hollow chamber 36. The support area 43a is formed as a continuation of the hollow chamber 36, which is separated from the hollow chamber 36 by the bottom plate 19. The damping element 39a is pressed into the support area 43a in order to avoid false flows bypassing the damping element 39a. Alternatively, the damping element 39a can also be glued in or firmly and sealingly connected in a similar manner with the support area 43a.

FIG. 2 shows in a lateral view and in section a door-closing damper 10 in accordance with a further embodiment, having a damping element 39b arranged on the sliding element 12, wherein the sliding element 12 is shown fully extended. Now the distinguishing features of the further embodiment of the door-closing damper 10, which are different from the distinguishing features already described by FIG. 1, is more accurately described by FIG. 2.

A bottom plate 19 is formed as one piece with the damper body 14 at the closed end 18, against which the spring 42 is supported and which delimits the hollow chamber 36.

A bore 13 as an extension of the elongated recess 44 is applied to the sliding element 12. In accordance with manufacturing technology, the bore 13 and the recess 44 are designed as a continuous bore applied centered in the longitudinal extension direction of the sliding element 12.

The cross section of the bore 13 simultaneously defines the opening 35b, in which a damping element 39b, made of a porous material, for example a sinter material, is arranged. The damping element 39a is used as a flow resistance material for the air flowing out of the opening 38a, and by its position in the bore defines the extension of the recess 44. The damping element 39a simultaneously is used as a support for the spring 42 within the recess 44.

The support area 43b is formed by the area of the inner wall of the bore 13 bordering the recess 44. The damping element 39b is pressed into the support area 43b in order to avoid false flows bypassing the damping element 39a. Alternatively, the damping element 39a can also be glued in or firmly and sealingly connected in a similar manner with the support area 43a.

FIG. 3 shows in a lateral view and in section a still further embodiment of a door-closing damper 10, having a damping member 39a arranged at the closed end 18 of the damper body 14, a pin 46 arranged in the hollow chamber and a completely extended sliding element 12. Now, the distinguishing features of this still further embodiment of the door-closing damper 10, which are different from the distinguishing features already described by FIG. 1, are more accurately described by means of FIG. 3.

The sliding body 12 has an elongated recess 44, which extends in its longitudinal extension direction and is attached to its end 32 assigned to the closed end 18 of the receiving chamber and into which the spring 42 arranged in the receiving chamber 20 extends. At the same time, a pin 46 is formed on the inner contour of the closed end 18 of the receiving chamber 20 and extends in the longitudinal extension direction of the receiving chamber 20. The pin 46 has approximately the same length as the elongated recess 44 in the sliding element 12 so that, in the completely pushed-in state of the sliding element 12, the pin 46 extends substantially completely into its recess 44. The spring 42 arranged in the receiving chamber 20 is conducted over the pin 46 and is movably arranged on its outer contour.

A bottom plate 19 is formed on the closed end 18 and, arranged at right angles and centered thereto, the pin 46 is formed as one piece with the damper body 14. The spring 42 is supported on the bottom plate 19. An opening 38a in the form of a bore has been cut into the bottom plate 19 laterally next to the pin 46, or the spring 42. A damping element 39a made of a porous material, for example a sinter material, is arranged in a support area 43a on the side of the bore 38a facing away from the hollow chamber 36. The damping element 39a is used as a flow resistance material for the air flowing out of the opening 38a.

In a lateral view and in section, FIG. 4 shows the door-opening damper 10 in accordance with FIG. 3 with the sliding element 12 completely pushed in. A gap 48 is formed in the sliding element 12 between the pin 46 and the recess 44 extending in the longitudinal extension direction, in which the spring 42 is movably arranged. With the sliding element 12 substantially completely pushed in, the spring 42 is squared away or compressed in the gap 48.

For the purpose of a further more detailed explanation, a circle V has been drawn in FIG. 4 around the lower closed section of the damper body 14, which marks the area represented in an enlarged partial lateral representation and in partial section in FIG. 5. Furthermore, a circle VI is drawn at the upper open section of the damper body 14 in FIG. 4, which marks the area represented in an enlarged partial lateral representation and in partial section in FIG. 6.

In an enlarged partial lateral representation and in partial section of FIG. 4, FIG. 5 shows the lower closed area of the damper body 14 with the completely pushed-in sliding element 12. The hollow chamber 36 shown in FIG. 3 is almost completely occupied by the pushed-in sliding element 12, so that only the recess 40 forms a hollow chamber. Because of the compression action of the sliding element 12 provided with the sealing lip 34, the volume of air from the hollow chamber 36 flows through the opening 38a into the damping member 39a and damped, i.e. with an increased flow resistance, through the latter.

FIG. 6 shows in an enlarged partial lateral representation and in partial section of FIG. 4 an area arranged on the outer contour of the damper body 14 at the open end 16 of the receiving chamber 20.

A protrusion 50, which extends approximately ring-shaped on the inner contour of the receiving chamber 20, is formed on the inner wall section of the receiving chamber 20, which is assigned to the open end 16 of the damper body and is in contact with each sliding surface of the sliding element 12. The protrusion can also be formed by a separate element, for example a retaining ring.

A protrusion 52, represented in FIG. 3, which encloses the sliding element 12 in a ring shape, is arranged on the sliding element 12 between the outer contour 24 of the sliding element 12 and the inner contour 28 of the receiving chamber 20. When pulling the sliding element 12 at least partially out of the receiving chamber 20, the protrusion 52 impacts on the protrusion 50, which is formed on the inner wall section of the receiving chamber 20 associated with the open end 16 of the damper body 14.

In an alternative embodiment, FIG. 7 shows, in an enlarged partial lateral representation and in partial section, the upper open area 16 of the damper body 14 with the sliding element 12 completely pushed in. In this case the sliding element 12 does not have a formed stop element 22, but rather is flattened. With this embodiment, a cabinet door, not represented, can rest flush against the furniture body, not represented.

In a schematically perspective representation, FIG. 8 shows a furniture body 54 with a closing flap 56, which is damped by a door-closing damper 10, in accordance with the embodiment according to FIG. 3. In this case, the door-closing damper 10 is arranged on the furniture body 54 so that during the closing movement the closing flap 56 impacts on the door-closing damper 10. The door-closing damper 10 can also have a magnetic snap-in arrangement 11 or similar contact device for the releasable connection of the door-closing damper 10 with the closing flap 56. In addition, or alternatively, not represented, such contact or closing arrangements can be provided on the furniture body 54 or on the closing flap 56.

The door-closing damper 10 can be inserted into a blind bore in the furniture body 54. In this case, the damper body 14 has a shoulder 60, which circles it at least partially, on the outer contour assigned to its open end 16, which limits the insertion depth of the damper body 14 into the blind bore. The shoulder 60 is shown, by way of example, in FIG. 3.

1. A door-closing damper (10), having a stop element (22) guided in an elongated damper body (14) with an open end and a closed end (16, 18), wherein the damper body (14) has a receiving chamber (20) for receiving a sliding element (12) which is connected with the stop element (22), on an outer contour the sliding element (12) has at least one sliding face which rests against an interior wall section (26) of the receiving chamber (20) assigned to the open end (16) of the damper body (14), a sealing device (34) resting against the inner contour (28) of the receiving chamber (20) is arranged on an end (32) of the sliding element (12) projecting into the receiving chamber (20), the end (32) of the sliding element (12) projecting into the receiving chamber (20) and the sealing device (34) form a hollow space (36) with the inner contour (28) of the receiving chamber (20) in which, when the sliding element (12) is charged with a pressure, a counter-pressure is exerted on the sliding element (12) from an air pressure built up in the hollow space (36), and for reducing the air pressure the hollow space (36) has at least one opening (38a, 38b) for an escape of the air, and a damping member (39a, 39b) works together with the opening (38a, 38b) to form a flow resistance to the air escaping through the opening (38a, 38b), the door-closing damper (10) comprising:
the sealing device (34) having at least one elastic sealing lip (34) which when as the air pressure is built up in the hollow space (36) formed by the end (32) of the sliding element (12) with the sealing device (34) extending into the receiving chamber (20) and the inner contour (28) of the receiving chamber (20), is pushed against the inner contour (28) of the receiving chamber (20), a sliding connection is created which is largely air-tight.

2. The door-closing damper in accordance with claim 1, wherein the damping member (39a, 39b) has a porous material to resist an air flow.

3. The door-closing damper in accordance with claim 2, wherein the damping member (39a, 39b) is made of one of a sinter metal, a plastic foam, a textile material, a felt material and a material providing a resistance to the air flow.

4. The door-closing damper in accordance with claim 3, wherein the opening (38a) is arranged at the closed end (18) of the damper body (14).

5. The door-closing damper in accordance with claim 4, wherein the damping member (39a) is fitted into a support area (43a) formed on the damper body (14) and an entire air flow passes through the damping member (39).

6. The door-closing damper in accordance with claim 5, wherein the opening (38b) is arranged on the sliding element (12).

7. The door-closing damper in accordance with claim 4, wherein the damping member (39b) is fitted into a support area (43b) formed on the damper body (14) and an entire air flow passes through the damping member (39b).

8. The door-closing damper in accordance with claim 7, wherein the damping member (39a, 39b) is arranged on a side of the opening (38a, 38b) facing away from the hollow chamber (36).

9. The door-closing damper in accordance with claim 8, wherein the damping member is arranged on a second side of the opening (38a, 38b) facing the hollow chamber (36).

10. The door-closing damper in accordance with claim 9, wherein the damping member is arranged inside the opening (38a, 38b).

11. The door-closing damper in accordance with claim 10, wherein the damper body (12) has a spring (42) arranged in the receiving chamber (20) and pushes the sliding element (12) at least partially out of the receiving chamber (20), and has a spring force against which the sliding element (12) can be pushed into the receiving chamber (20).

12. The door-closing damper in accordance with claim 11, wherein the elastic sealing lip (34) is substantially inclined toward the closed end (18) of the receiving chamber (20), is at least partially spaced apart from the outer contour (24) of the sliding element (12) and is arranged at the end (32) of the sliding element (12) extending into the receiving chamber (20).

13. The door-closing damper in accordance with claim 12, wherein an underpressure created in the hollow space (36) spaces the elastic sealing lip (34) of the sealing device in the space (30) between the inner contour (28) of the receiving chamber (20) and the outer contour (24) of the sliding element (12) apart from the inner contour (28) of the receiving chamber (20) during an at least partial pull-out of the sliding element (12) from the receiving chamber (20) so that air can flow through the space (30) between the inner contour (28) of the receiving chamber (20) and the outer contour (24) of the sliding element (12) beyond the sealing lip (34) into the hollow space (36).

14. The door-closing damper in accordance with claim 13, wherein at least one protrusion (50) is formed on the interior wall section of the receiving chamber (20) associated with the open end (16) of the damper body (14) which contacts the at least one sliding face of the sliding element (12).

15. The door-closing damper in accordance with claim 14, wherein the at least one protrusion (52) is formed on the sliding element (12) between the outer contour (24) and the inner contour (28) which during the at least partial pull-out of the sliding element (12) out of the receiving chamber (20) strikes the protrusion (50) formed on the interior wall section of the receiving chamber (20) associated with the open end (16) of the damper body (14).

16. The door-closing damper in accordance with claim 15, wherein the damper body (14) is insertable into a blind bore (58) in a receiver body (54), the damper body (14) has a shoulder (60) at least partially encircling on an outer contour (24) associated with the open end (16) which limits an insertion depth of the damper body (14) in the blind bore (58).

17. The door-closing damper in accordance with claim 16, wherein the sliding body (12) has an elongated recess (44) which at least partially extends substantially in a direction of a longitudinal extension and is arranged at the closed end (18) of the receiving chamber (20), into which the spring (42) arranged in the receiving chamber (20) extends.

18. The door-closing damper in accordance with claim 17, wherein a pin (46) which extends in the longitudinal extension direction of the receiving chamber (20) is formed on the inner contour of the closed end (18) of the receiving chamber (20) which, in the completely pushed-in state of the sliding element (12), extends substantially completely into a recess (44) which runs along the longitudinal extension.

19. The door-closing damper in accordance with claim 18, wherein the spring (42) arranged in the receiving chamber (20) is conducted over the pin (46) and movably arranged on an outer contour of the pin (46), and a space (48) formed between the pin (46) and the recess (44) extends in the longitudinal extension direction in the sliding element (12) so that the spring (42) is movably arranged on an inner contour of the recess.

20. The door-closing damper in accordance with claim 19, wherein with the sliding element (12) substantially completely pushed-in, the spring (42) is compressed in the space (48) between the pin (46) and the recess (44).

21. The door-closing damper in accordance with claim 20, wherein the stop element (22) has a detent head (23) which projects at least partially over an edge area (17) of an opening at the open end (16) of the damper body (14) and which, with the substantially completely pushed-in sliding element (12), is stopped on the edge area (17).

22. The door-closing damper in accordance with claim 21, wherein the sliding element (12) is integrated with the sealing device (34).

23. The door-closing damper in accordance with claim 22, wherein the stop element has a releasable connection of the door-closing damper with a connecting element.

24. A door-closing damper (10), having a stop element (22) guided in an elongated damper body (14) with an open end and a closed end (16, 18), wherein the damper body (14) has a receiving chamber (20) for receiving a sliding element (12) which is connected with the stop element (22), wherein on an outer contour the sliding element (12) has at least one sliding face resting against an interior wall section (26) of the receiving chamber (20) assigned to the open end (16) of the damper body (14), a sealing device (34) resting against the inner contour (28) of the receiving chamber (20) is arranged near an end of the sliding element (12) projecting into the receiving chamber (20), wherein the end (32) of the sliding element (12) projecting into the receiving chamber (20) and the sealing device (34) form a hollow space (36) together with the inner contour (28) of the receiving chamber (20) in which when the sliding element (12) is charged with a pressure, a counter-pressure is exerted on the sliding element (12) by the air pressure built up in the hollow space (36), and for reducing the air pressure the hollow space (36) has at least one opening (38a, 38b) for the escape of the air, the door-closing damper comprising:
at least one of the opening having a diameter D less than 0.2 mm and a ratio of a cross-sectional surface of the sliding element (12) embodied as a piston in an area facing the hollow chamber (36) and an opening cross section of the opening (38a, 38b) being greater than 4000/1.

25. The door-closing damper in accordance with claim 24, wherein the diameter D of the opening (38a, 38b) is less than 0.1 mm.

26. The door-closing damper in accordance with claim 24, wherein a damping member works with the opening (38a, 38b).

27. The door-closing damper in accordance with claim 1, wherein the damping member (39a, 39b) is made of one of a sinter metal, a plastic foam, a textile material, a felt material and a material providing a resistance to the air flow.

28. The door-closing damper in accordance with claim 1, wherein the opening (38a) is arranged at the closed end (18) of the damper body (14).

29. The door-closing damper in accordance with claim 1, wherein the opening (38b) is arranged on the sliding element (12).

30. The door-closing damper in accordance with claim 1, wherein the damping member (39a, 39b) is arranged on a side of the opening (38a, 38b) facing away from the hollow chamber (36).

31. The door-closing damper in accordance with claim 1, wherein the damping member is arranged on a second side of the opening (38a, 38b) facing the hollow chamber (36).

32. The door-closing damper in accordance with claim 1, wherein the damping member is arranged inside the opening (38a, 38b).

33. The door-closing damper in accordance with claim 1, wherein the damper body (12) has a spring (42) arranged in the receiving chamber (20) and pushes the sliding element (12) at least partially out of the receiving chamber (20), and has a spring force against which the sliding element (12) can be pushed into the receiving chamber (20).

34. The door-closing damper in accordance with claim 1, wherein the elastic sealing lip (34) is substantially inclined toward the closed end (18) of the receiving chamber (20), is at least partially spaced apart from the outer contour (24) of the sliding element (12) and is arranged at the end (32) of the sliding element (12) extending into the receiving chamber (20).

35. The door-closing damper in accordance with claim 1, wherein an underpressure created in the hollow space (36) spaces the elastic sealing lip (34) of the sealing device in the space (30) between the inner contour (28) of the receiving chamber (20) and the outer contour (24) of the sliding element (12) apart from the inner contour (28) of the receiving chamber (20) during an at least partial pull-out of the sliding element (12) from the receiving chamber (20) so that air can flow through the space (30) between the inner contour (28) of the receiving chamber (20) and the outer contour (24) of the sliding element (12) beyond the sealing lip (34) into the hollow space (36).

36. The door-closing damper in accordance with claim 1, wherein at least one protrusion (50) is formed on the interior wall section of the receiving chamber (20) associated with the open end (16) of the damper body (14) which contacts the at least one sliding face of the sliding element (12).

37. The door-closing damper in accordance with claim 1, wherein the damper body (14) is insertable into a blind bore (58) in a receiver body (54), the damper body (14) has a shoulder (60) at least partially encircling on an outer contour (24) associated with the open end (16) which limits an insertion depth of the damper body (14) in the blind bore (58).

38. The door-closing damper in accordance with claim 1, wherein the sliding body (12) has an elongated recess (44) which at least partially extends substantially in a direction of a longitudinal extension and is arranged at the closed end (18) of the receiving chamber (20), into which the spring (42) arranged in the receiving chamber (20) extends.

39. The door-closing damper in accordance with claim 1, wherein the stop element (22) has a detent head (23) which projects at least partially over an edge area (17) of an opening at the open end (16) of the damper body (14) and which, with the substantially completely pushed-in sliding element (12), is stopped on the edge area (17).

40. The door-closing damper in accordance with claim 1, wherein the sliding element (12) is integrated with the sealing device (34).

41. The door-closing damper in accordance with claim 1, wherein the stop element has a releasable connection of the door-closing damper with a connecting element.
